(19) United States
(12) Patent Application Publication
(10) Pub. No.: US 2006/0157509 A1
(43) Pub. Date: Jul. 20, 2006

(54) Applicator for personal care compositions

(75) Inventors: Richard H. Seager, Mystic, CT (US); Alfred J. Astoreca, Annandale, NJ (US)

Correspondence Address: BACHMAN & LAPOINTE, P.C., 900 CHAPEL STREET, SUITE 1201, NEW HAVEN, CT, 06510, US

(73) Assignee: Plastek Industries, Inc.

(21) Appl. No.: 11/035,610

(22) Filed: Jan. 14, 2005

(51) Int. Cl. B67D 5/64

(52) U.S. Cl. 222/168; 424/65

(57) ABSTRACT

A personal care applicator apparatus has a barrel, a piston upwardly moveable within the barrel, and an actuator coupled to the piston to shift the piston upward. The barrel has a bottom end, a top end, a front face, a back face, and an external shoulder. The shoulder faces generally upward and has a first portion spanning the front and back faces along a left side and a second portion spanning the front and back faces along a right side. The shoulder lacks a portion centrally along at least a first of the front and back faces.

### BACKGROUND OF THE INVENTION

The invention relates to personal care. More particularly, the invention relates to applicators for underarm antiperspirant and/or deodorant.

A well-developed art exists regarding dispenser/applicators for personal care products. One particular area involves applicators for solid or gel antiperspirant and/or deodorant compositions. Applicators for solid and gel compositions are typically thoroughly similar to each other, with a piston (platform) upwardly movable within a cylinder (barrel) to progressively drive the composition out the barrel upper end. Due to the relative lack of stiffness of many gels, dispensers for such gels commonly include foraminate screen-like applicator elements across the upper end of the barrel. Exemplary applicators are shown in U.S. Pat. Nos. 5,007,755, 6,435,748, and D331,534. A common feature of such applicators is in the presence of a shoulder circumscribing the barrel near the upper end to separate a neck portion of the barrel from a main body portion of the barrel. The neck may telescopically be received in a corresponding portion of a cover, with a rim of the cover abutting or closely facing the shoulder. Exemplary shoulder depths are 0.5-2.0 mm.

### SUMMARY OF THE INVENTION

A personal care applicator apparatus has a barrel, a piston upwardly moveable within the barrel, and an actuator coupled to the piston to shift the piston upward. The barrel has a bottom end, a top end, a front face, a back face, and an external shoulder. The shoulder faces generally upward and has a first portion spanning the front and back faces along a left side and a second portion spanning the front and back faces along a right side. The shoulder substantially lacks a portion centrally along at least a first of the front and back faces. This may provide a locally smooth transition area between a barrel main body portion and a barrel neck. The cover may substantially overlap or underlap this area to provide a desired aesthetic and/or ergonomic configuration.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a front view of an applicator apparatus.

FIG. 2 is a partially exploded view of the apparatus of FIG. 1.

FIG. 3 is a side view of the apparatus of FIG. 1.

FIG. 4 is a front/back view of an alternate apparatus.

Like reference numbers and designations in the various drawings indicate like elements.

### DETAILED DESCRIPTION

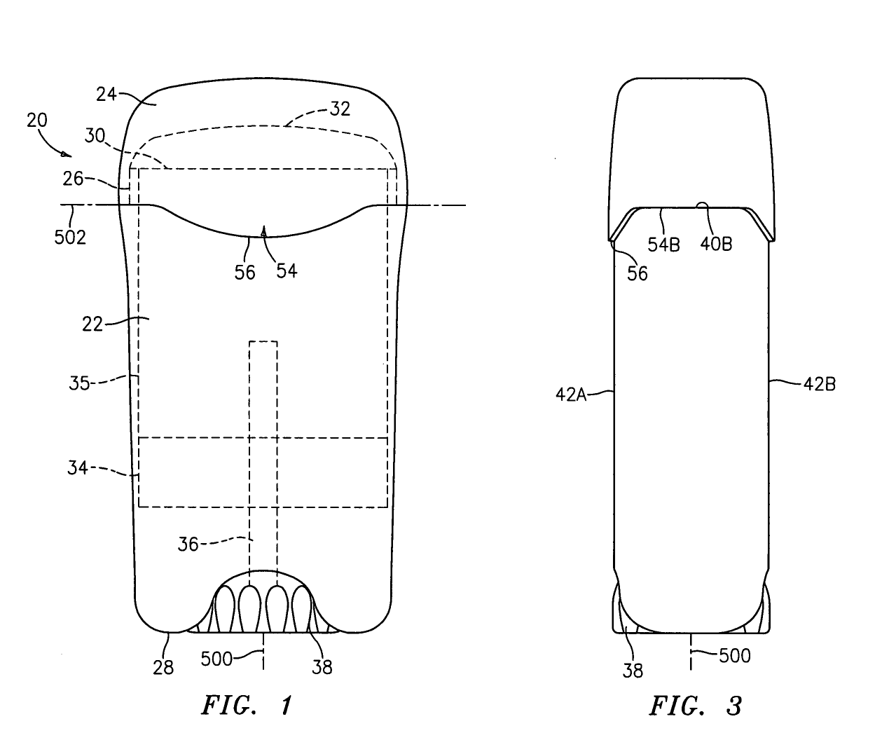

FIG. 1 shows an applicator 20 having a barrel 22 and a cover 24 in an installed position on a barrel neck 26. The barrel extends from a bottom (base) end 28 to an upper end formed by a rim 30. A foraminate applicator 32 may be secured across the barrel upper end for applying gel-compositions. A platform 34 supports the composition 35 and is, itself, supported by an actuating mechanism 36 (e.g., a screw-type elevator mechanism) having a user-engagable element such as a knob 38 for progressively raising the platform toward the barrel upper end so as to discharge the composition.

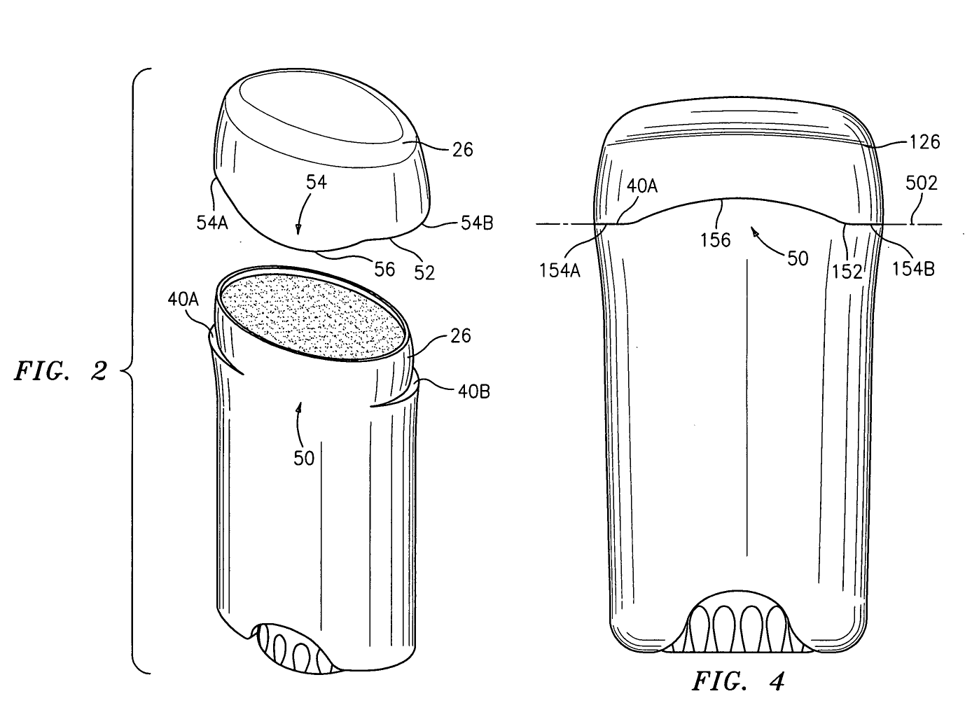

As heretofore described, the apparatus 20 may be of any of a wide variety of known or yet-developed configurations. FIG. 2, however, shows the barrel as including a shoulder having first and second portions 40A and 40B at respective left and right sides of the barrel and spanning front and back faces 42A and 42B (FIG. 3) of the barrel. The exemplary shoulder is generally upwardly facing, lying substantially in a single transverse plane 502 at the base of the neck 26. The exemplary shoulder portions 40A and 40B are crescent-shaped, having a maximum thickness at extreme left and right sides, respectively, and decreasing circumferentially toward the front and back faces. Exemplary thickness for such maximum is 0.5-2.0 mm. In the exemplary embodiment, by tapering to zero, there is essentially no shoulder along major portions of the front and back faces (e.g., along at least approximately 20% of the circumference and on each face at least about 1.0 cm). This provides a smooth contour in a transition region 50 between the main portion of the base and the neck. The exemplary cover 26 has a rim 52 with extreme left and right portions 54A and 54B which abut the shoulder portions 40A and 40B, respectively. Therefrom, toward the front and back portions of the rim, the exemplary cover 26 has a protruding portion 54 along which the rim has a centrally convex portion 56 (with concave transition portions on either side). When installed, the convex portion 56 protrudes below the shoulder plane 502 (FIG. 1, e.g., by about 0.5-1.5 cm). During cover installation and removal, with the user's thumb or other finger spanning the rim portion 56, the smooth transition region 50 is felt, avoiding discomfort.

FIG. 4 shows an alternate cover 126 installed on the barrel 22. This cover has a rim 152 with portions 154A and 154B similarly abutting the barrel shoulder portions. However, rather than the protruding front and back portions 54, front and back portions are recessed with the rim having a centrally concave portion 156. The smooth transition area 50 allows use of either of the caps 26 or 126 (or a cap of another configuration) with the same configuration of barrel while still achieving an aesthetically and ergonomically pleasing result otherwise unobtainable with a continuous rim. This allows a plurality of different-appearing applicators to be economically marketed by varying only the cover.

In another variation (not shown) the shoulder may continue around substantially the entire circumference but greatly taper so as to be substantially non-existent along at least one of the front or back faces (e.g., a local depth of less than about 0.3 mm). Barrels and/or caps with other than nominal front-to-back symmetry may also be used.

One or more embodiments of the present invention have been described. Nevertheless, it will be understood that various modifications may be made without departing from the spirit and scope of the invention. For example, the principles may be applied in a redesigning/engineering of any of a variety of existing applicators or in the design/engineering of yet new applicators. Accordingly, other embodiments are within the scope of the following claims.

What is claimed is:

1. A personal care applicator apparatus comprising:
a barrel having:
a bottom end;
a top end;
a front face;
a back face; and
an external shoulder facing generally upward and having a first portion spanning the front and back faces along a left side and a second portion spanning the front and back faces along a right side, but substantially lacking a portion centrally along at least a first of the front and back faces.

2. The apparatus of claim 1 wherein:
the first and second portions are essentially coplanar.

3. The apparatus of claim 1 wherein:
at least at the shoulder, the barrel has a generally elliptical transverse cross-section.

4. The apparatus of claim 1 wherein:
at least at the shoulder, the barrel has a generally obround transverse cross-section.

5. The apparatus of claim 1 further comprising:
a piston upwardly moveable within the barrel from a first position to a second position; and
an actuator coupled to the piston to shift the piston upward.

6. The apparatus of claim 5 further comprising:
a solid stick of at least one of an underarm antiperspirant and underarm deodorant atop the piston; and
a removable cap over the barrel upper end.

7. The apparatus of claim 5 further comprising:
a gel body of at least one of an underarm antiperspirant and underarm deodorant atop the piston;
a foraminate applicator secured to the barrel proximate the upper end; and
a removable cap over the barrel upper end and applicator.

8. The apparatus of claim 1 further comprising:
a removable cap over the barrel upper end having a lower rim characterized by:
left and right portions essentially abutting the shoulder first and second portions, respectively; and
a centrally convex protruding portion extending below the left and right portions along the first of the front and back faces.

9. The apparatus of claim 8 wherein the barrel has essentially front-to-back symmetry.

10. The apparatus of claim 1 further comprising:
a removable cap over the barrel upper end having a lower rim characterized by:
left and right portions essentially abutting the shoulder first and second portions, respectively; and
a centrally concave recessed portion above the left and right portions along the first of the front and back faces.

11. The apparatus of claim 10 wherein the cap has essentially front-to-back symmetry.

12. The apparatus of claim 1 wherein the barrel has essentially front-to-back symmetry.

13. A personal care applicator apparatus comprising:
a barrel having:
a bottom end;
a top end;
a front face;
a back face; and
an external shoulder facing generally upward and having a first portion spanning the front and back faces along a left side and a second portion spanning the front and back faces along a right side,
a piston upwardly moveable within the barrel from a first position to a second position;
an actuator coupled to the piston to shift the piston upward; and
a removable cap over the barrel upper end having a lower rim, the lower rim having:
left and right portions essentially abutting the shoulder first and second portions, respectively; and
at least one of:
a centrally concave recessed portion above the left and right portions along a first of the front and back faces; and
a centrally convex protruding portion extending below the left and right portions along said first of the front and back faces.

14. The apparatus of claim 13 wherein:
the shoulder lacks a portion centrally along at least said first of the front and back faces.

15. The apparatus of claim 13 further comprising:
a solid stick of at least one of an underarm antiperspirant and underarm deodorant atop the piston.

16. The apparatus of claim 13 wherein the barrel has essentially front-to-back symmetry.
